(19) United States
(12) Patent Application Publication
(10) Pub. No.: US 2004/0060579 A1
(43) Pub. Date: Apr. 1, 2004

(54) Cleaning solution and method for cleaning ceramic parts using the same

(76) Inventors: Jaung-Joo Kim, Suwon-si (KR); Jae-Jun Ryu, Seoul (KR); Pil-Kwon Jun, Yongin-si (KR); Dong-Jin Park, Osan-si (KR); Jin-Sung Kim, Suwon-si (KR); Sang-Mun Chon, Yongin-shi (KR)

Correspondence Address: VOLENTINE FRANCOS, P.L.L.C., Suite 150, 12200 Sunrise Valley Drive, Reston, VA, 20191, US

(21) Appl. No.: 10/601,195

(22) Filed: Jun. 23, 2003

(30) Foreign Application Priority Data
Jun. 24, 2002 (KR) 2002-35422

(51) Int. Cl. B08B 3/12; B08B 7/00; B08B 7/04

(52) U.S. Cl. 134/28; 134/1; 134/3; 134/26; 134/29; 134/19; 134/30

(57) ABSTRACT

Cleaning solution is used to clean ceramic parts using the same. The cleaning solution includes about 5-30% by weight of fluoric salt, about 10-20% by weight of organic acid, about 30-50% by weight of organic solvent, and about 50% by weight of water. The ceramic parts may be portions of an etching apparatus on which plasma reaction by-products are adsorbed. Plasma reaction by-products are removed from the ceramic parts dipping the parts into the cleaning solution, followed by rinsing and heat treatment.

### BACKGROUND OF THE INVENTION

1. Field of the Invention

The present invention relates to a cleaning solution and to a method for cleaning ceramic parts using the same, and more particularly, the present invention relates to a cleaning solution for cleaning ceramic parts which have absorbed by-products of plasma reaction, and to a method for cleaning such ceramic parts using the same.

2. Description of the Related Art

Generally, a semiconductor fabrication process includes forming a thin film layer and selectively etching the thin film layer such that desired portions of the thin film layer remain. The etching process is carried out in an etching apparatus using a variety of process gases, a high-frequency or ultra high-frequency currents for optimizing reactivity of the process gases and processing conditions, and various plasma generators. The etching apparatus usually includes a variety of ceramic parts for achieving good insulation.

In etching a thin film layer, processing gases are chemically reacted with the thin film layer and photoresist patterns thereon, and as a result, various by-products of the chemical reaction are created and adsorbed into the ceramic parts of the etching apparatus to thereby contaminate the ceramic parts. When the thin film layer on the substrate is etched using the etching apparatus of which ceramic parts are contaminated with the reaction by-products, pollutants adsorbed into the ceramic parts, such as the reaction by-products, are dropped off onto the substrate and constitute foreign particles on the substrate, which reduces processing yield or throughput.

In order to prevent the formation of such particles on the substrate, each ceramic part of the etching apparatus is periodically cleaned according to a predetermined cleaning schedule. Typically, the ceramic parts are cleaned by scrubbing with a rough fiber, treatment with beads, dry ice treatment, or the like.

However, rough fiber scrubbing can cause damage to the surface of the ceramic part, and is labor intensive. Likewise, the beads treatment is an intricate process, which is labor intensive as well. Also, dry ice treatment suffers from high equipment cost and presents a danger to workers due to ultra-low processing temperatures.

Accordingly, there is needed for a wet cleaning method using a cleaning solution of low cost, high efficiency and easy handling. Japanese Patent Laid-Open Publication No. 8-306651 discloses a composite including fluoric ion of more than 0.15 mol for cleaning a semiconductor substrate, and U.S. Pat. No. 5,709,756 also discloses a cleaning solution including hydro-oxy amine and ammonium fluoride for removing organic matter on a semiconductor substrate. However, cleaning solutions and methods are mainly proposed for removing organic matter and polymers on the semiconductor substrate, and are not suitable for cleaning various ceramic parts of an etching apparatus.

### SUMMARY OF THE INVENTION

A first feature of the present invention is to provide a novel cleaning solution for cleaning ceramic parts, such a ceramic parts which have absorbed reaction by-products of a plasma treatment.

A second feature of the present invention is to provide a novel cleaning method for cleaning ceramic parts, such a ceramic parts which have absorbed reaction by-products of a plasma treatment.

A third feature of the present invention is to provide a novel cleaning method of cleaning ceramic parts of an etching apparatus on which etching by-products are adsorbed.

According to an aspect of the present invention, there is provided a cleaning solution comprising about 5-30% by weight of fluoric salt, about 10-20% by weight of organic acid, about 30-50% by weight of organic solvent, and about 50% by weight of water.

According to another aspect of the present invention, there is provided a method of cleaning ceramic parts on which plasma reaction by-products are adsorbed. The ceramic parts are dipped into a cleaning solution including about 5-30% by weight of fluoric salt, about 10-20% by weight of organic acid, about 30-50% by weight of organic solvent, and about 50% by weight of water. After rinsing the ceramic parts, the ceramic parts are treated with heat.

According to still another aspect of the present invention, there is provided a method of cleaning ceramic parts on which etching by-products are adsorbed as the result of etching a layer formed on a semiconductor substrate after introducing the substrate into a dry etching apparatus containing the ceramic parts. The method includes dipping the ceramic parts into a first cleaning solution including about 5-30% by weight of fluoric salt, about 10-20% by weight of organic acid, about 30-50% by weight of organic solvent, and about 50% by weight of water after separating the ceramic parts from the etching apparatus, and then dipping the ceramic parts into a second cleaning solution of sodium hydroxide aqueous solution. After rinsing the ceramic parts, the ceramic parts are treated with heat.

The present invention allows for a reduction in time expended in cleaning the ceramic parts, and further minimizes damage to the ceramic parts.

### BRIEF DESCRIPTION OF THE DRAWINGS

The above and other objects, features and advantages of the present invention will become more readily apparent from the detailed description that follows, with reference to the accompanying drawings, in which:

FIGS. 1A to 1C are cross sectional views showing a process for forming a contact hole by etching an oxide layer and an anti-reflective layer using a photoresist pattern;

FIG. 2 is a flow chart showing a method of cleaning ceramic parts of an etching apparatus using a cleaning solution according to a first embodiment of the present invention; and

FIG. 3 a flow chart showing a method of cleaning ceramic parts of an etching apparatus using a cleaning solution according to a second embodiment of the present invention.

### DETAILED DESCRIPTION OF THE PREFERRED EMBODIMENTS

Hereinafter, preferred embodiments of the present invention will be described in detail with reference to accompanying drawings. As one example, the present invention is described in relation to a process for forming a contact hole on a semiconductor substrate.

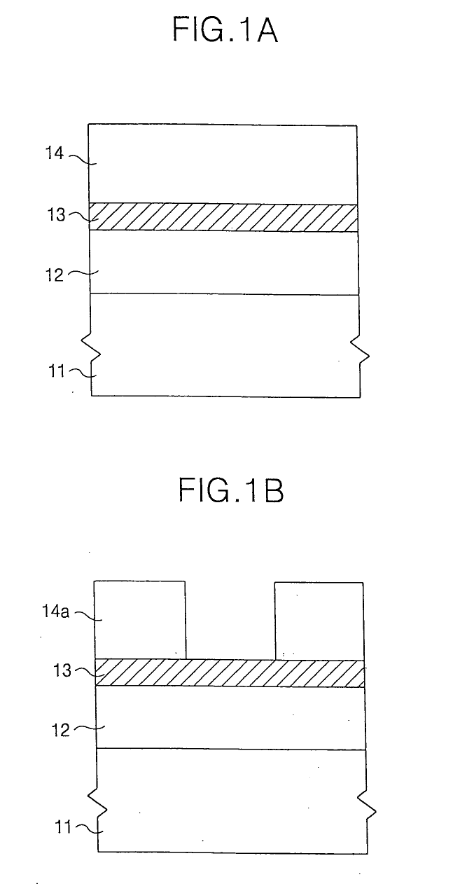

FIGS. 1A to 1C are cross sectional views showing a process for forming a contact hole by etching an oxide layer and an anti-reflective layer using a photoresist pattern.

Referring to FIG. 1A, an insulating layer 12 is formed on a semiconductor substrate 11 by depositing an oxide to a thickness of 4000 Å. Then, an anti-reflective layer 13 is formed on the insulating layer 12 by depositing an anti-reflective compound. As a preferred anti-reflective compound, EUV44 (trade name manufactured by Nissan Chemical Co.), SNAC90 (trade name manufactured by Nissan Chemical Co.), etc. can be used. In these anti-reflective compounds, the basic resin includes polyacrylate, wherein a portion of the polyacrylate is replaced with an anthracene group. Also included is a cross-linking agent as an additive. When this component is coated on the insulating layer and then heated, a cross-linked polymer, which is insoluble in most solvents, is formed by the cross-linking agent.

The thickness of the anti-reflective layer is variable according to the refractive index thereof. Generally, the thickness is about 400-600 Å. The anti-reflective layer reduces the refractive coefficient of an exposure light during a photolithography process and also reduces undesired effects due to a diffused reflection of light by an underlying layer.

A photoresist is coated on the anti-reflective layer 13 to a thickness of about 10,000 Å to thereby form a photoresist film 14.

Referring to FIG. 1B, a photoresist pattern 14a is formed by exposing a predetermined region of the photoresist film 14 using a mask pattern and then developing the exposed photoresist film 14 to remove a soluble portion of the photoresist film 14. During the exposure process, the anti-reflective layer prevents the reflection of the light by the underlying layer to improve a pattern profile.

Referring to FIG. 1C, a portion of the anti-reflective layer 13 which is exposed by the photoresist pattern is firstly etched by a conventional dry etching method, and then the insulating layer 12 is also etched to thereby obtain a contact hole 20 on a predetermined portion of the insulating layer 12. The etching of the anti-reflective layer 13 and the insulating layer 12 is preferably implemented using a chemical reaction in an etching apparatus using a plasma gas. A mixture of a CxFy (wherein x and y are positive numbers) based gas, oxygen, argon, and carbon monoxide can be used as an etching gas.

When a layer is etched in the above-described etching apparatus, a plurality of by-products is generated through chemical reaction between the etching gas and the layer on the semiconductor substrate. Attempts are made to thoroughly exhaust the chemical by-products from the etching apparatus, but some of the by-products are not exhausted and are instead adsorbed into the various parts of the etching apparatus.

Since the layer being etched is varied as the etching process is progressed, the etching gas reaction to the layer is naturally varied, and therefore the reaction by-products are formed into a polymer including a variety of components. The reaction by-products adsorbing on the parts of the etching apparatus can become harder after a long lapse of time, and the removal thereof becomes all the more difficult.

The etching process for fabricating the semiconductor is carried out with a photoresist pattern the example of FIGS. 1A to 1C. However, the etching process can be performed without a photoresist pattern. A number of experiments relating to etching processes show that the reaction by-products are more firmly adsorbed into the etching apparatus in the absence of a photoresist pattern. Therefore, the reaction by-products are more difficult to remove from the etching apparatus when no photoresist pattern is used.

In order to investigate components that are to be removed by a cleaning solution, a plurality of etching processes was performed under various conditions and the by-products of each etching process were analyzed as shown in Table 1 (presented below) and Table 2 (presented later). Table 1 shows the analyzed by-products of etching processes performed with a photoresist pattern, and Table 2 shows the same in the absence of a photoresist pattern.

TABLE 1

| | Objective layer | Etching gas | Chief by-products |
|---|---|---|---|
| Etching process | SiN/BPSG | CxFy/O2/Ar | C, F, O |
| on oxide based | PE-TEOS/SiO2 | CxFy/O2/Ar/N2 | C, F |
| layer | | | |
| Etching process | Si | CxFy/O2/Cl/HBr | C, Si, O, Cl |
| on polysilicon | Poly/Wsix | SxFy/O2/Cl/HBr | C, Si, O, Cl |
| based layer | | | |
| Etching process | TiN/Al, TiN/Ti | SxFy/Cl | C, O, Cl, Al |
| on metal based | | | |
| layer | | | |

Hereinafter, the etching process using a photoresist pattern is explained referring to the Table 1.

The objective layer (i.e., the layer being etched) in the etching process using photoresist pattern is usually classified as an oxide-based layer, a polysilicon-based layer, and a metal-based layer. The oxide-based layer can be formed into a boron-phosphorous silicon glass (BPSG) layer, plasma enhanced tetraethylorthosilicate (PE-TEOS) layer, and the like. An anti-reflective layer for preventing a diffused reflection of light in an exposure process for forming the photoresist pattern is formed on the above-mentioned layers. For example, a silicon nitride layer can be used as the anti-reflective layer.

The polysilicon-based layer includes a multi-layer having a polysilicon layer and a silicide layer, and also includes some portion of a silicon substrate, which is to be etched out in forming a trench.

The anti-reflective layer reduces the refractive coefficient of an exposure light during a photolithography process and also reduces undesired effects due to a diffused reflection of light by an underlying layer. The metal-based layer includes a multi-layer having a barrier metal layer and a metal layer.

Each of the above-mentioned layers was etched under a respective process condition in the etching apparatus, and by-products of the etching process adsorbed into the ceramic parts of the etching apparatus were analyzed. The resulting analysis shows that the by-products of the etching process using a photoresist pattern include at least anyone of C, F, O, Si, Cl, Al, Ti, etc.

The etching process without using a photoresist pattern is explained referring to Table 2.

TABLE 2

| | Objective layer | Etching gas | Chief by-products |
|---|---|---|---|
| Etching process by | SiO2/SiN | CxFy/O2/Ar | C, F |
| using hard mask | | | |
| Forming a spacer | SiN | CxFy/O2/Ar | C, F |
| and etching | | | |
| process on an | | | |
| etching stop layer | | | |
| Etch-back process | Poly | CxFy/O2/Cl | C, F, Cl, Al |
| | W | O2/Ar | Ti, W, C, F, O, N |

The etching process without using a photoresist pattern usually includes a process of forming a pattern using a hard mask, a process of forming a spacer, a process for etching an etching stop layer, and an etch-back process. The objective layer includes an oxide layer, a nitride layer, and poly-based layer.

Each of the above-mentioned layers was etched under a respective process condition of the respective mentioned processes, and by-products of the etching process adsorbed into the ceramic parts of the etching apparatus were analyzed. The resulting analysis shows that the by-products of the etching process without photoresist pattern include at least any one selected from the group consisting of C, F, O, N, Cl, Al, and Ti.

Accordingly, an effective cleaning solution preferably removes polymers including the components of the by-products shown in Table 1 and Table 2.

The cleaning solution of the present invention includes about 5-30% by weight of fluoric salt, about 10-20% by weight of organic acid, about 30-50% by weight of organic solvent, and about 50% by weight of water.

During the etching process, a fluoric salt of the cleaning solution dissolves silicon oxide included in the by-products, and produces silicon fluoride. The fluoric salt is at least any salt selected from the group consisting of NH₄F, NH₄HF₂, NaF, and KHF₂. Among these fluoric salts, ammonium fluoride (NH₄F) is most preferable when considering stability and cost. The amount of fluoric salt in the cleaning solution is within the range of about 5-10% by weight. When the amount is less than 5% by weight, a cohesive force caused by fluoric ions is weak and the cleaning of the by-products is not advantageous. When the amount exceeds 10% by weight, the amount of the organic solvent and water is reduced and so the solubility is reduced, which is not preferable.

An applicable organic acid includes an acetic acid (CH₃COOH). The organic acid is added for improving a swelling effect. According to a large number of experiments by the present inventors, the reaction by-products are cleaned to a certain extent even though the organic acid is not added, however, there is a problem in that the salt is re-precipitated.

As for the organic solvent, dimethyl acetamid (hereinafter, referred to as DMAC), mono ethanol amine (MEA), or a mixture thereof can be used. Among these solvents, DMAC is most preferred.

The amount of the organic solvent in the solution is in the range of about 30-50% by weight. When the amount is less than 30% by weight, the solubility is reduced, and when the amount exceeds 50% by weight, the amount of the salt should be reduced and the cleaning effect thus becomes very weak, which is not desirable.

In the meantime, water dissolves the salt and increases the polarity of the cleaning solution. The amount of water in the solution is in the range of about 20-50% by weight. When the amount is less than 20% by weight, the salt is not completely dissolved, and the cleaning effect becomes weak. When the amount exceeds 50% by weight, the swelling effect and the solubility are decreased, which is not desirable.

Hydroxylammonium sulfate ((NH₃OH)₂SO₄) can be added to further reinforce the swelling effect. However, when the amount of the hydroxylammonium sulfate ((NH₃OH)₂SO₄) exceeds 50% by weight of the solution, the amount of the salt or the organic solvent is reduced, and the cleaning effect becomes very weak.

Hereinafter, a method of cleaning ceramic parts in an etching apparatus using the cleaning solution of the present invention will be described.

Embodiment 1

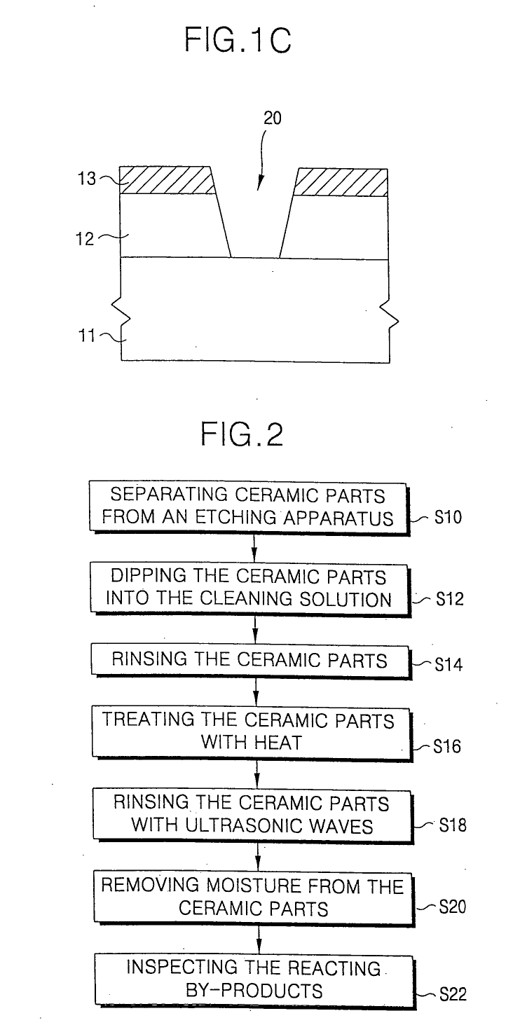

FIG. 2 is a flow chart illustrating a cleaning method of ceramic parts of an etching apparatus using a cleaning solution according to a first embodiment of the present invention.

Firstly, ceramic parts of the etching apparatus are separated from the etching apparatus (step S10). The reaction by-products were previously adsorbed into the ceramic parts during etching of a layer on the semiconductor substrate.

The etching apparatus of the first embodiment is directed to an apparatus for etching a layer using photoresist patterns.

According to the etching apparatus of the present embodiment, the photoresist film or layer, the solubility of which to an alkaline solution changes after exposure to a light source, is exposed by a light source through a photomask having a pattern to be transferred onto the substrate surface. The photoresist film is then developed to remove those portions of the photoresist film having a high solubility (i.e., exposed portions for a positive type photoresist), while remaining portions having a low solubility (i.e., unexposed portions for a positive type photoresist) form a photoresist pattern. Layers underlying the photoresist pattern are then etched using the photoresist pattern as an etching mask, and thereafter the photoresist pattern may be removed to obtain a pattern used in forming conductive patterns, wiring, electrodes, as well as other components of a semiconductor device. Therefore, the reaction by-products adsorbed into the ceramic parts are produced in etching the photoresist pattern and the layers underlying the photoresist pattern.

Then the separated ceramic plates are dipped into a cleaning solution at a temperature of at least about 30° C. (step S12). A plurality of the ceramic parts can be simultaneously dipped into the same cleaning solution.

The dip time in the cleaning solution is determined by a cleaning cycle of the ceramic parts, and by the amount of reaction by-products adsorbed onto the ceramic parts. When the cleaning cycle is long and the amount of reaction by-products is large, the dip time in the cleaning solution is prolonged. In contrast, when the cleaning cycle is short and the amount of the hardened organic material, i.e., the reaction by-products, is small, the dip time in the cleaning solution is shortened. Therefore, the dip time in the solution is not limited to a certain time period. Preferably, however, the dip time is in a range of 1 hour to 5 hours.

According to repeated experiments by the present inventors, the reaction by-products were hardly removed from the ceramic parts when the temperature of the cleaning solution is less than about 30° C. Therefore, it is preferable that the temperature of the cleaning solution is more than about 30° C. In addition, it was also confirmed that the higher the temperature of the cleaning solution, the shorter the dip time. However, when the temperature of the cleaning solution is exceedingly high, there are problems in that the ceramic parts can damaged and worker safety is reduced.

Next, the ceramic parts are taken out of the cleaning solution and rinsed (step S14). When the ceramic parts are taken out of the cleaning solution, most of the reaction by-products are swelled so that an adhering force of the by-products is weakened and the by-products are in a state of separating from the ceramic parts. Accordingly, most of the reaction by-products can be removed during rinsing.

The ceramic parts from which the reaction by-products are washed out are treated with heat (step S16). The heat treatment process is carried out for removing a very small amount of the reaction by-products remaining on the ceramic parts as blots. The ceramic parts are introduced into a furnace at a temperature of about more than 650° C., and the heat treatment is carried out on the ceramic parts in the furnace. Then, the ceramic parts are rinsed using an ultrasonic wave for completely removing the remaining reaction by-products (step S18).

The heat treatment and the ultrasonic wave rinsing process can remove even a very small amount of the reaction by-products remaining on the ceramic parts in an etching apparatus. However, in some cases, the above-described heat treatment and the ultrasonic wave rinsing process can be omitted since the reaction by-products may be sufficiently removed by the dipping and rinsing processes.

Next, the ceramic parts are baked to thereby remove moisture from the ceramic parts (step S20). Then, it is inspected whether or not the reaction by-products remain on the ceramic parts (step S22). The inspection can be performed using an optical microscope or a scanning microscope. If the reaction by-products remain on the ceramic parts, the above steps S10 to S20 are repeated again. Accordingly, the reaction by-products produced during an etching process on a photoresist-patterned layer are sufficiently cleaned by sequentially carrying out the above-described process steps. However, the same sequential process steps when applied in relation to a non-photoresist-patterned layer may be insufficient.

The etching of a non-photoresist-patterned layer can be carried out not only when etching a whole surface of an objective layer, but also when selectively etching a partial surface of an objective layer. The objective layer can be selectively etched by using a hard pattern as an etching mask. The reaction by-products created in etching the non-photoresist-patterned layer are more firmly adsorbed into the ceramic parts than when etching the photoresist-patterned layer, and as a result, the removal of the reaction by-products is more difficult in relation to etching the non-photoresist-patterned layer. Therefore, when the non-photoresist-patterned layer is etched, the reaction by-products may not be sufficiently removed by the first embodiment of the present invention.

Hereinafter, a novel method of cleaning ceramic parts onto which the reaction by-products are adsorbed during the etching process of a non-photoresist-patterned layer will be described.

Embodiment 2

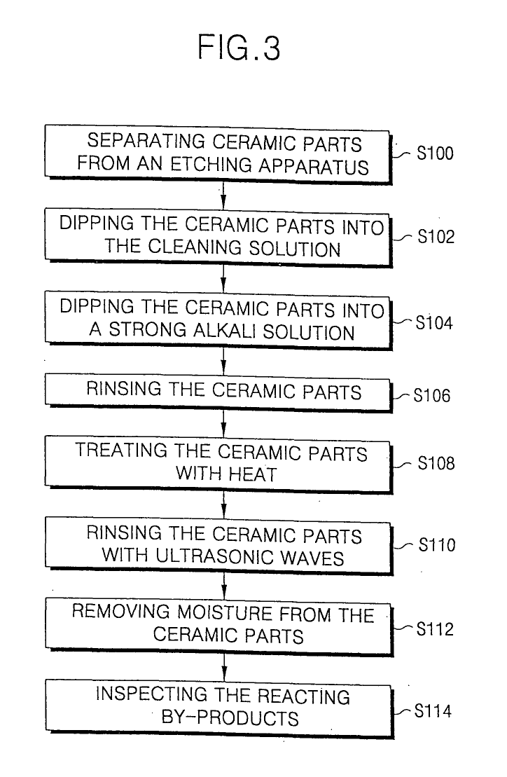

FIG. 3 is a flow chart illustrating a cleaning method of ceramic parts of an etching apparatus using a cleaning solution according to a second embodiment of the present invention.

Firstly, ceramic parts of the etching apparatus are separated from an etching apparatus (step S100). Reaction by-products were previously adsorbed into the ceramic parts during etching of the layer on the semiconductor substrate. The etching apparatus of the second embodiment can etch the non-photoresist-patterned layer as well as the photoresist-patterned layer.

Then the separated ceramic plates are dipped into a cleaning solution for about 2 hours at a temperature of at least about 30° C. (step S102). A plurality of the ceramic parts can be simultaneously dipped into the same cleaning solution.

The dip time in the cleaning solution is determined by a cleaning cycle of the ceramic parts, and by the amount of reaction by-products adsorbed onto the ceramic parts. When the cleaning cycle is long and the amount of reaction by-products is large, the dip time in the cleaning solution is prolonged. In contrast, when the cleaning cycle is short and the amount of the hardened organic material, i.e., the reaction by-products, is small, the dip time in the cleaning solution is shortened. Therefore, the dip time in the solution is not limited to a certain time period.

Next, the ceramic parts are taken out of the cleaning solution and again dipped into a strong alkali solution (step S104). When the ceramic parts are taken out of the cleaning solution, most of the reaction by-products are swelled so that an adhering force of the reaction by-products is weakened. However, the reaction by-products created in etching the non-photoresist-patterned layer are more firmly adsorbed onto the ceramic parts, so that dipping the ceramic parts into the cleaning solution may not entirely remove the reaction by-products from the ceramic parts. Therefore, the ceramic parts are again dipped into the strong alkali solution so as to further swell the reaction by-products.

The dip time in the alkali solution is determined by a cleaning cycle of the ceramic parts, and by the amount of reaction by-products adsorbed onto the ceramic parts. When the cleaning cycle is long and the amount of reaction by-products is large, the dip time in the alkali solution is prolonged. In constrast, when the cleaning cycle is short and the amount of the hardened organic material, i.e., the reaction by-products, is small, the dip time in the alkali solution is shortened. Therefore, the dip time in the alkali solution is not limited to a certain time period.

In addition, the dip time in the alkali solution is also determined by a temperature of the alkali solution. The higher the temperature of the alkali solution, the shorter the dip time. However, when the temperature of the alkali solution is exceedingly high, there are problems in that the ceramic parts can be damaged and worker safety can be compromised.

As a preferred embodiment of the present invention, a sodium hydroxide (NaOH) aqueous solution can be used as the strong alkali solution. Preferably, the sodium hydroxide (NaOH) aqueous solution is in a range of about 1N to 3N in normal concentration.

When the concentration of the sodium hydroxide (NaOH) aqueous solution is low, the reaction by-products are not sufficiently swelled so that an adhering force of the reaction by-products is not weakened. When the concentration of the sodium hydroxide (NaOH) aqueous solution is high, there are problems in that the ceramic parts can be damaged and the production cost is increased.

According to repeated experiments by the present inventors, the reaction by-products were sufficiently swelled so as to be detached from the ceramic parts or removed in subsequent processes when the temperature of the sodium hydroxide (NaOH) aqueous solution was more than about 30° C.

Before the ceramic parts are dipped into the strong alkali solution, the rinsing step for washing out the cleaning solution remaining on the ceramic parts can be further carried out for preventing pollution caused by the strong alkali solution.

Next, the ceramic parts are taken out of the strong alkali solution and washed out, or rinsed, using de-ionized water for removing a residual alkali solution (step A106). When the ceramic parts are taken out of the strong alkali solution, most of the reaction by-products are swelled so that an adhering force of the reaction by-products is weakened and the reaction by-products are in a state of separation from the ceramic parts. Accordingly, most of the reaction by-products can be washed out during the rinsing process.

The ceramic parts from which the reaction by-products are washed out are treated with heat (step S108). The heat treatment process is carried out for removing a very small amount of the reaction by-products remaining on the ceramic parts as blots. The ceramic parts are introduced into a furnace at a temperature of about more than 650° C., and the heat treatment is carried out on the ceramic parts in the furnace. Then, the ceramic parts are rinsed using an ultrasonic wave for completely removing the remaining reaction by-products (step S110). The heat treatment and the ultrasonic wave rinsing process can be omitted if warranted.

Next, the ceramic parts are baked to thereby remove moisture from the ceramic parts (step S112). Then, it is inspected whether or not the reaction by-products remain on the ceramic parts (step S114). The inspection can be performed by using an optical microscope or a scanning microscope.

According to embodiments of the present invention, the ceramic parts adsorbing the reaction by-products created during etching of the non-photoresis-patterned layer can be cleaned so as to remove the reaction by-products, as well as the ceramic parts adsorbing the reaction by-products created during etching of the photoresist-patterned layer.

Therefore, the ceramic parts in an etching apparatus can be sufficiently cleaned by dipping into the cleaning solution and rinsing of the cleaning solution, which can reduce cleaning time. Furthermore, damage to the ceramic parts and the creation of particles during the cleaning process can be minimized. Still furthermore, there is an advantage in that cleaning cost can be reduced as compared with a conventional cleaning method.

Although the present invention has been described in detail above, various changes, substitutions and alterations can be made thereto without departing from the true spirit and scope of the invention as defined by the appended claims.

What is claimed is:

1. A cleaning solution comprising about 5-30% by weight of fluoric salt, about 10-20% by weight of organic acid, about 30-50% by weight of organic solvent, and about 50% by weight of water.

2. The cleaning solution as claimed in claim 1, wherein said fluoric salt includes ammonium fluoride.

3. The cleaning solution as claimed in claim 1, wherein said organic acid includes acetic acid.

4. The cleaning solution as claimed in claim 1, wherein said organic solvent includes dimethyl acetamid.

5. The cleaning solution as claimed in claim 1, further comprising about 10% or less by weight of (NH₃OH)₂SO₄.

6. A method of cleaning ceramic parts on which plasma reaction by-products are adsorbed, comprising:
dipping the ceramic parts into a cleaning solution including about 5-30% by weight of fluoric salt, about 10-20% by weight of organic acid, about 30-50% by weight of organic solvent, and about 50% by weight of water;
rinsing said ceramic parts; and
treating said ceramic parts with heat.

7. The method of cleaning ceramic parts as claimed in claim 6, wherein said by-products are at least one selected from the group consisting of C, N, O, Si, Cl, Al, and Ti.

8. The method of cleaning ceramic parts as claimed in claim 6, wherein said fluoric salt includes ammonium fluoride.

9. The method of cleaning ceramic parts as claimed in claim 6, wherein said organic acid includes acetic acid.

10. The method of cleaning ceramic parts as claimed in claim 6, wherein said organic solvent includes dimethyl acetamid.

11. The method of cleaning ceramic parts as claimed in claim 6, wherein said cleaning solution further comprises about 10% or less by weight of (NH₃OH)₂SO₄.

12. The method of cleaning ceramic parts as claimed in claim 6, wherein a temperature of said cleaning solution is at least about 30° C.

13. The method of cleaning ceramic parts as claimed in claim 6, wherein said ceramic parts are dipped into the cleaning solution for about 1 hour to about 5 hours.

14. The method of cleaning ceramic parts as claimed in claim 6, further comprising the step of dipping said ceramic parts into a strong alkali solution after said dipping of the ceramic parts into the cleaning solution.

15. The method of cleaning ceramic parts as claimed in claim 14, wherein a temperature of said strong alkali solution is at least about 30° C.

16. The method of cleaning ceramic parts as claimed in claim 14, wherein said strong alkali solution includes a sodium hydroxide aqueous solution.

17. The method of cleaning ceramic parts as claimed in claim 14, wherein a concentration of said sodium hydroxide aqueous solution is in a range of about 1N to about 3N.

18. The method of cleaning ceramic parts as claimed in claim 6, further comprising treating said ceramic parts with an ultrasonic wave and baking said ceramic parts after said treating of said ceramic parts with heat.

19. A method of cleaning ceramic parts on which etching by-products are adsorbed, comprising:
using an etching apparatus to etch a layer formed on a semiconductor substrate, wherein etching by-products are absorbed onto ceramic parts of the etching apparatus;
dipping said ceramic parts into a first cleaning solution including about 5-30% by weight of fluoric salt, about 10-20% by weight of organic acid, about 30-50% by weight of organic solvent, and about 50% by weight of water;
dipping said ceramic parts into a second cleaning solution of sodium hydroxide aqueous solution;
rinsing said ceramic parts; and
treating said ceramic parts with heat.

20. The method of cleaning ceramic parts as claimed in claim 19, wherein a whole surface of said layer is exposed over an upper surface of said semiconductor substrate.

21. The method of cleaning ceramic parts as claimed in claim 19, wherein said layer is formed under a nitride based hard mask pattern.

22. The method of cleaning ceramic parts as claimed in claim 19, wherein said fluoric salt includes ammonium fluoride.

23. The method of cleaning ceramic parts as claimed in claim 19, wherein said organic acid includes acetic acid.

24. The method of cleaning ceramic parts as claimed in claim 19, wherein said organic solvent includes dimethyl acetamid.

25. The method of cleaning ceramic parts as claimed in claim 19, wherein said cleaning solution further comprises about 10% or less by weight of (NH₃OH)₂SO₄.
